(19) United States
(12) Patent Application Publication
(10) Pub. No.: US 2008/0126142 A1
(43) Pub. Date: May 29, 2008

(54) Promotional in-store demonstration coordination system and method

(76) Inventor: Rae Anne Campellone, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/605,621

(22) Filed: Nov. 28, 2006

(51) Int. Cl. G06Q 10/00

(52) U.S. Cl. 705/5

(57) ABSTRACT

The invention comprises a system and method for facilitating the scheduling and performance of a promotional in-store demonstration. The system and method coordinates information between the primary entities involved in the demonstration, including vendors, retailers and event affiliates. The system may include a web-based interface that enables each entity to interact with the other entities with regard to scheduling and executing the demonstration. Retailers indicate available demonstration times and locations. Vendors may reserve available times/locations. Event affiliates receive requests to provide demonstration labor, supplies and equipment for the scheduled demonstration. Vendors may establish accounts to pay for reserved demonstrations and are provided post-demonstration reports. The reports provide information to the vendor regarding the effectiveness of the demonstration and accountability of the demonstration labor.

### FIELD OF THE INVENTION

The present invention relates to a method and system for scheduling promotional in-store demonstrations, and more particular, to such a method and system which uses a network based interface for coordination of parties, including retailers, product vendors and laborers.

### BACKGROUND OF THE INVENTION

Product exposure is important to every vendor. Vendors attempt to expose their products to consumers in a variety of ways. The most common way is through media advertising. Another way, however, is through direct product demonstration or promotion. In order to increase the probability that the demonstration or promotion will reach target consumers, a vendor may demonstrate their product or service at a retail store. Such a demonstration or promotion may be used, for example, to introduce a new product or service. The demonstration or promotion might also be used to increase consumer awareness of an existing product or service.

For example, one type of retail store that has become increasingly popular is the warehouse shopping center or discount retailer, such as Costco or Sam's Club. These warehouse stores generally provide shoppers with goods at reduced prices, but often require the purchaser to obtain the goods packaged in bulk. There are several types of consumers that may benefit from buying in bulk. One consumer is the small business owner such as a family owned restaurant. Another consumer is the common American family. These consumers not only appreciate the monetary savings but also the time saved in reducing the number of trips to the retail store. Especially in today's fast paced society, a small business owner or parent typically places a very high value on their time. Correspondingly, the less time spent shopping for necessities is highly valued, and purchasing sundries in bulk is a welcome opportunity.

However, purchasing items in bulk requires that the consumer make an informed decision regarding the product so that the consumer will be satisfied with the purchase. For products that the consumer frequently purchases, the risk of buying a product that is unsatisfactory is low. In contrast, when the consumer wishes to try a new product, purchasing that new product in bulk has an increased risk. That risk being, if the consumer has purchased a new product and is not satisfied, the consumer may have a large quantity of the unwanted product. Vendors may attempt to reduce the consumer's perceived risk by providing in-store demonstrations or “samplings” of their products. By doing so, consumers may sample a product and make an informed decision regarding the product. In particular, after sampling a new product, a consumer is more likely to purchase the product, assuming the product meets or exceeds their expectations.

Vendors and retail stores currently undertake a complex and problematic process for organizing, scheduling and coordinating in-store demonstrations or promotions. This process generally involves interaction with several third parties or intermediaries. These third parties or intermediaries increase the probability that the demonstration will be successful.

Most vendors do not have dedicated labor for demonstrations, and do not maintain a supply of the various items which may be necessary for such demonstrations. For example, an in-store demonstration is typically staffed by one or more personnel. The personnel may prepare product samples. In the case food, the food may be prepared at a small table and then be presented to consumers on napkins or plates. Further, because vendors may market their goods or services at various retailers in various geographic locations, vendors must somehow arrange for the demonstration labor and supplies at a multitude of disparate locations.

With respect to labor, vendors typically approach national agencies for staffing of their demonstrations/promotions. These national agencies offer temporary labor forces in the various locations where the vendor may wish to present a demonstration at a retailer location. The labor force in a particular geographic area, however, is typically provided by a local temporary labor firm, such that the national agency is merely the “middleman” in the process that organizes the local labor.

This has the drawback of increasing costs associated with the in-store demonstration because the national agency commonly marks up the actual cost of the demonstration labor so the national agency can make a profit. Thus, a vendor pays a substantially increased labor rate but may not receive a labor force that possess a skill level commensurate with the increased rate of pay. For example, a vendor may pay $20 per hour for demonstration labor, with half of that rate going to the national agency and the remainder allocated for the demonstration labor. The remaining $10 per hour is further divided between the local temporary labor firm and the actual employee. In effect, the employee may only actually receive $6-$8 per hour after the intermediaries take their portion of the demonstration labor rate. The result is that the vendor has paid a significant wage for the demonstration labor, but in reality receives a low paid and commonly unskilled worker.

Another drawback to the current process of arranging an in-store demonstration is that the national agency is remote to the process and has a low level of accountability. Since the in-store demonstration is commonly a brief event, usually 4-6 hours in duration, a quick response time to resolve problems is beneficial to the successful in-store demonstration. For example, should a complication arise at a scheduled in-store demonstration, such as an employee not showing up at the proper time, the retailer or vendor must contact the intermediary (national agency) in attempt to resolve the matter. Depending on issues such as time zones and store hours, by the time the national agency responds to the issue, the scheduled time for the in-store demonstration may have elapsed or the demonstration maybe completed.

Another drawback to the current process is that the national agencies are not accountable for effective and efficient execution of the in-store demonstration. The national agencies are able to cut numerous corners to maximize their profitability at the expense of the vendor and retailer. Common areas where the national agency may exploit the process are: careless management of the demonstration labor with respect to work time accountability, reduced professionalism, and disregard for demonstration effectiveness.

Currently, the in-store demonstration industry has no set standards. Instead, each national agency or other intermediary works in its own way and under its own guidelines. Inconsistent standard or lack of standards produces several drawbacks such as increased costs, uncertainty, fluctuations in labor effectiveness, demonstration management issues and logistic problems. Furthermore, the respective needs of the vendors and retailers are not adequately addressed in the current ad-hoc process of organizing, scheduling and coordinating a promotional in-store demonstration.

An improved method and system for promotional in-store demonstrations is desired that facilitates scheduling, and coordination of the various entities involved with the in-store demonstration, particularly with regard to reducing costs, providing competent labor, streamlining the process and providing accountability.

### SUMMARY OF THE INVENTION

The present invention comprises a method and system for facilitating scheduling of an in-store demonstration such as live food tasting, or product sampling event and for coordinating the interactions between the primary entities involved in the demonstration.

In one embodiment, the method of coordinating or facilitating in-store demonstrations. The method may include the step of obtaining retail inventory information from one or more retailers. Preferably, the retail inventory information comprises at least information regarding a retail store location and date and time availability for an in-store demonstration. The retail inventory information is provided to one or more vendors desiring to present an in-store demonstration. The vendors may make in-store demonstration reservations corresponding to the said retail inventory information. Vendors are charged for their making a reservation. Preferably, the payment comprises a service fee associated with facilitating and coordinating said in-store demonstration. Event affiliates are contacted on behalf of the vendor to acquire labor and associated supplies for effectuating the in-store demonstration. A schedule is provided to each retailer, vendor, and corresponding event affiliates, pertaining to each reserved in-store demonstration.

In one embodiment, the method is effectuated by a central demonstration coordinator or service. The coordinator obtains retail inventory information from retailers, accepts reservations and payments from vendors, and arranges the required labor and associated supplies for all the demonstrations, such as by contacting appropriate labor forces.

Each reserved in-store demonstration is conducted at the reserved retailer location and time. Preferably, information is gathered regarding each demonstration. The information may comprise information regarding the effectiveness of the demonstration (such as determined from consuming polling at the demonstration), and reporting of labor and other aspects of the demonstration. Preferably, this information is provided to the coordinator. The coordinator then provides an accountability report to each vendor regarding their demonstration.

One aspect of the invention is a system for coordinating and implementing in-store demonstrations. In one embodiment, the system comprises a computing system including communication links. The coordinator may operate one or more computing devices which are configured to accept and store retailer inventory information, accept vendor reservations, provide reports and schedule and the like.

In a preferred embodiment, the system includes one or more web sites which are accessible via a computer network such as the Internet. The web site may permit users to create accounts. Authorized users may enter retailer inventor information, make reservations, make payment, obtaining training and other information.

Further objects, features, and advantages of the present invention over the prior art will become apparent from the detailed description of the preferred embodiments which follows, when considered with the accompanying figures.

### BRIEF DESCRIPTION OF THE DRAWINGS

FIG. 1 is a schematic diagram of a system of the invention, illustrating various relationships/transactions between a coordinator, a retailer, a vendor and event affiliates;

FIG. 2A is a flow diagram illustrating a method in accordance with the present invention;

FIG. 2B is a flow diagram illustrating in detail a method comprising a step of establishing an account in accordance with the method illustrated in FIG. 2A;

FIG. 2C is a flow diagram illustrating in detail a method comprising a step of utilizing a vendor's account in accordance with the method illustrated in FIG. 2A;

FIG. 2D is a flow diagram illustrating in detail a method comprising a step of utilizing a retailer's account in accordance with the method illustrated in FIG. 2A;

FIG. 2E is a flow diagram illustrating in detail a method comprising a step of utilizing an event affiliate's account in accordance with the method illustrated in FIG. 2A;.

FIG. 2F is a flow diagram illustrating in detail a method comprising a step of utilizing a coordinator's account in accordance with the method illustrated in FIG. 2A; and

FIG. 2G is a flow diagram illustrating in detail a method comprising a step of utilizing a training account in accordance with the method illustrated in FIG. 2A.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

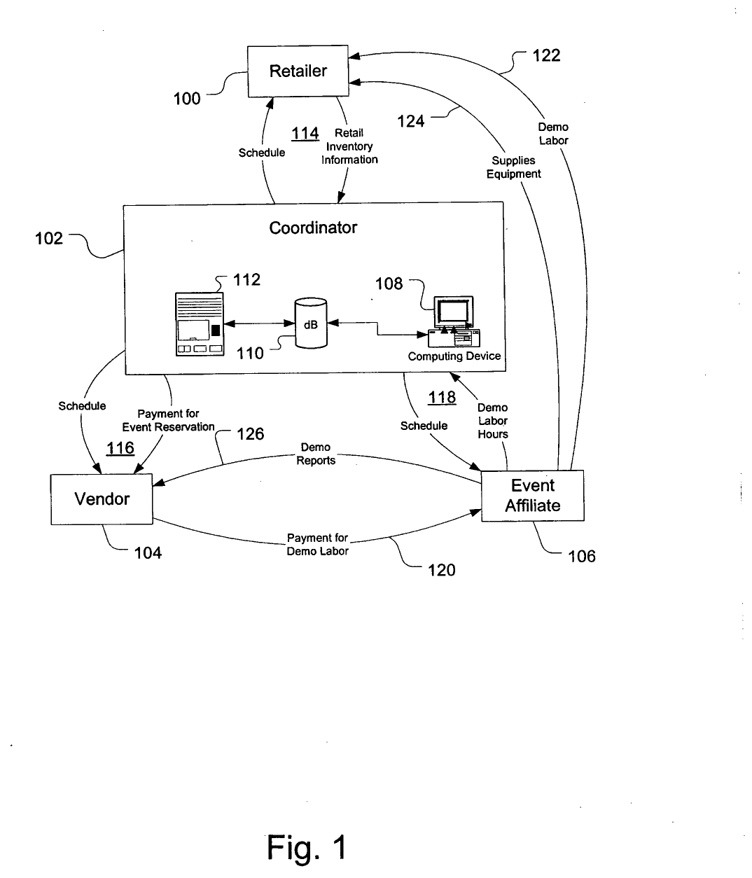

One embodiment of the invention is a system and method of coordinating and scheduling a promotional in-store demonstration. FIG. 1 schematically illustrates various relationships and transactions between various entities in accordance with the method and system. In one embodiment, these entities comprise one or more retailers 100, one or more coordinators 102, one or more product vendors 104, and one or more event affiliates 106

The retailer 100 may be a local or national retailer having stores or other locations at which consumers may purchase goods or services, such as groceries, clothing, hardware or the like. Examples of retailers may include Costco, Sam's Club, K-mart and Wal-Mart, to name a few.

The coordinator 102 may comprise an entity that functions as a facilitator for scheduling and coordinating the in-store demonstrations by providing a convenient and structured forum for efficient and transparent communication between entities. In one embodiment, the coordinator 102 operates a system for implementing the method of the invention.

The product vendor 104 maybe a vendor or producer of various goods or services. Examples of product vendors include Kraft Foods, Nabisco, Pepsi, and Kleenex, to name a few.

An event affiliate 106 may comprise an entity that provides or supplies demonstration labor, demonstrations supplies (i.e. paper napkins/cups) and/or equipment (i.e. microwave oven/hot-plate) for effectively executing the in-store demonstration.

In one embodiment, the system comprises a communication and computing system. The system may include a central coordination system. This central coordination system may be associated with the one or more coordinators 102 and may comprise one or more server computers 108, one or more data storage devices 110, and one or more interfaces 112, such as a website. Communication links maybe established between the various entities and the central coordination system. In one embodiment, these links maybe wired and/or wireless and may or may not be dedicated. In one embodiment, for example, an entity may access the website or interface 112 via the Internet.

In general, the method and system results in integration and coordination of in-store demonstration resources. The coordinator 102 serves as a central interface between retailers, vendors and event affiliates. The system and method of the invention permit retailers to identify available stores and times for demonstrations. Vendors can reserve available demonstration times and locations as identified by the retailers. Labor and supplies are coordinated with reserved demonstrations. Accountability to retailers, vendors and event affiliates is assured through the coordinator.

As one aspect of the invention, the system and method permit a retailer 100 to exchange information with the coordinator 102 regarding dates, locations and times that the retailer 100 has available for in-store demonstrations. These dates, locations and times then become a “retail inventory” which is posted, tracked and accounted for by the coordinator 102. This retail inventory may include various potential openings for demonstrations over a lengthy period of time, such as an 18-month interval. In this way, vendors 104 may schedule demonstrations well in advance. The retailer 100 may also access the posted information to ascertain the status of various dates and thus determine if the provided dates have been booked for in-store demonstrations.

As another aspect of the invention, a vendor 104 may establish a communication link 116 with the coordinator 102. The vendor 104 may schedule in-store demonstrations with specified retailers 100 and receive a schedule information from the coordinator 102. Event affiliates 106 may establish a link 118 with coordinator 102 for acquiring scheduled in-store demonstration requirements and for providing the coordinator 102 with information regarding available demonstration labor and other supplies. The vendor 104 may provide payment directly to an event affiliate 106 for the coordinator's services and associated demonstration labor, supplies and equipment rentals via a communication link 120. The event affiliate 106 may provide demonstration labor 122 and demonstration supplies/equipment 124 directly to a retailer 100 for an in-store demonstration. Upon conclusion of an in-store demonstration, the event affiliate 106 preferably provides demonstration reports 126. Preferably, these reports are standardized, though a vendor 104 may also request customized reports.

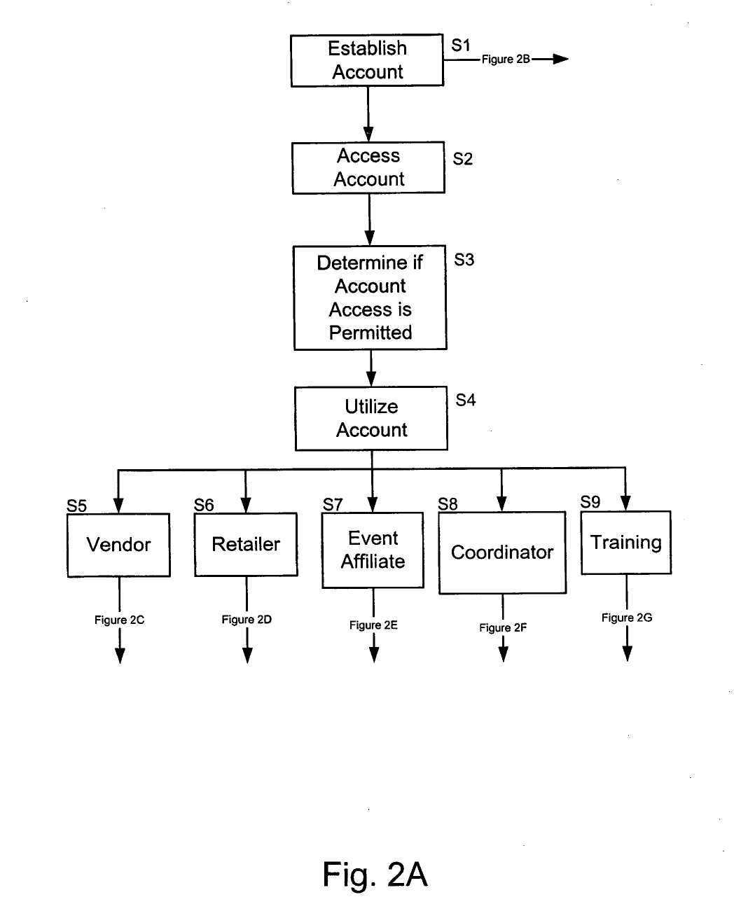

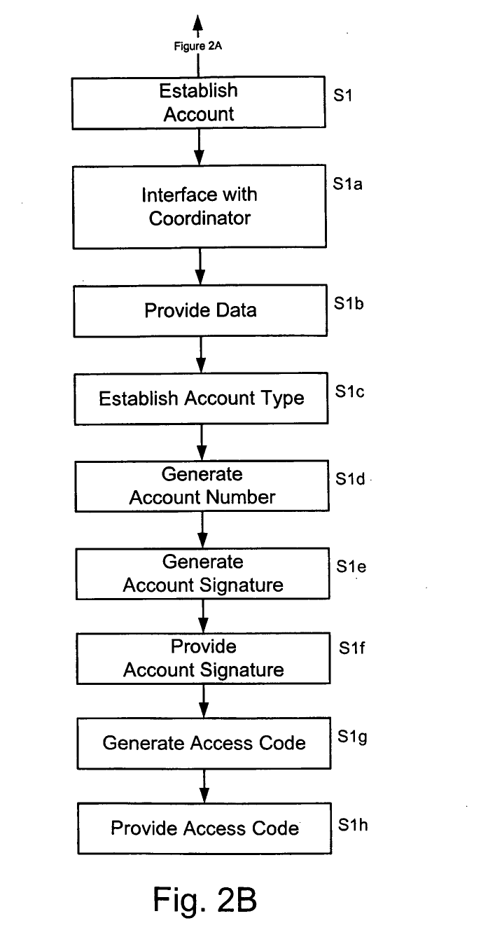

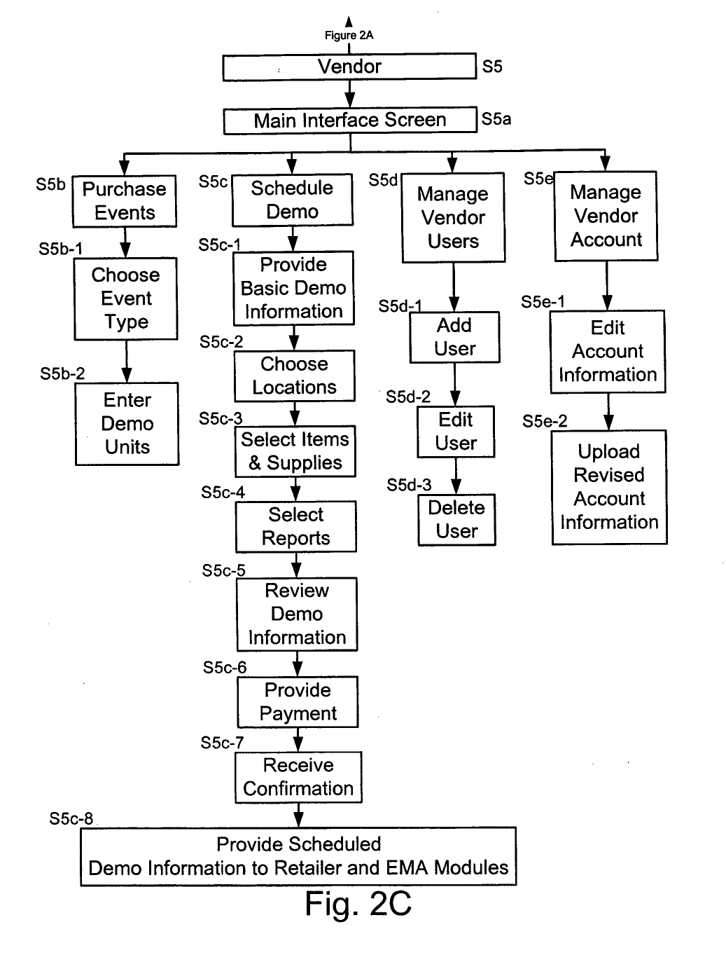

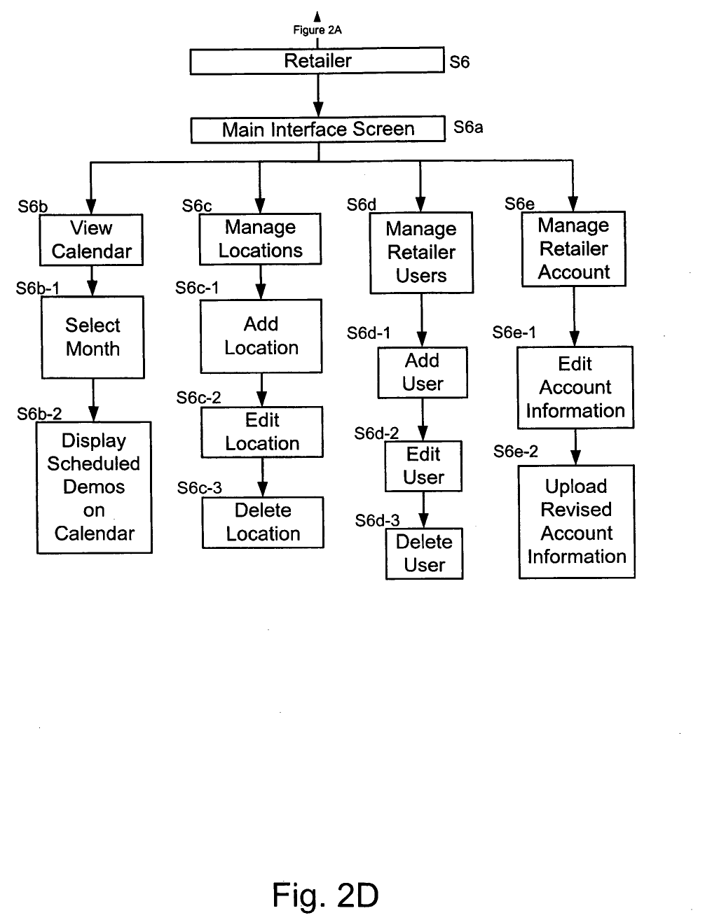

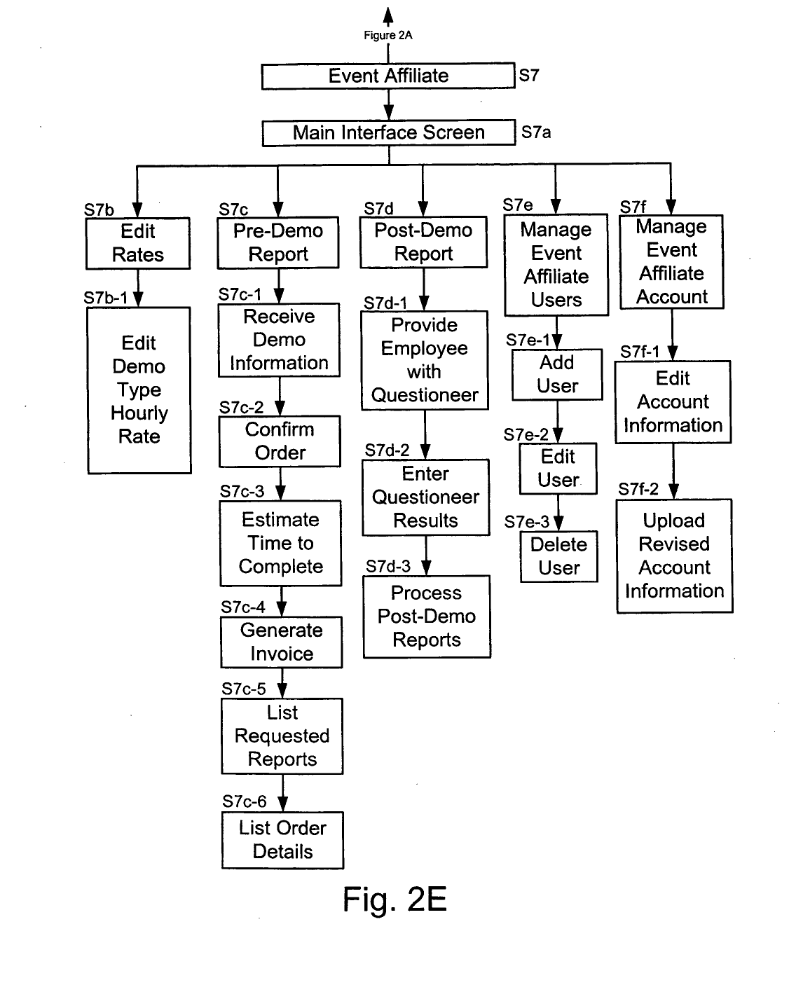

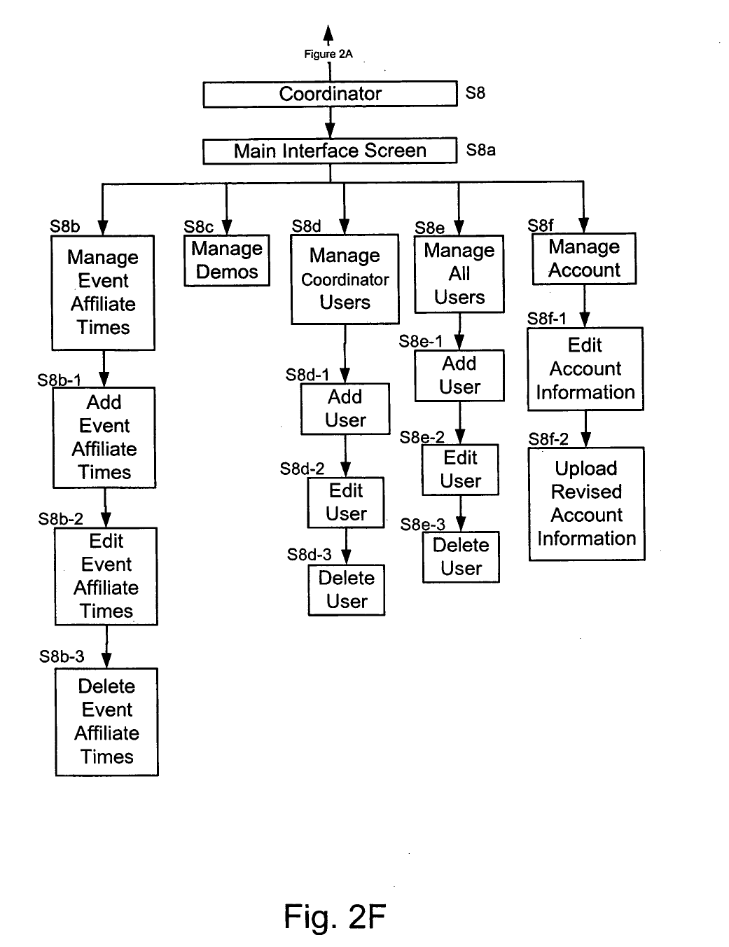

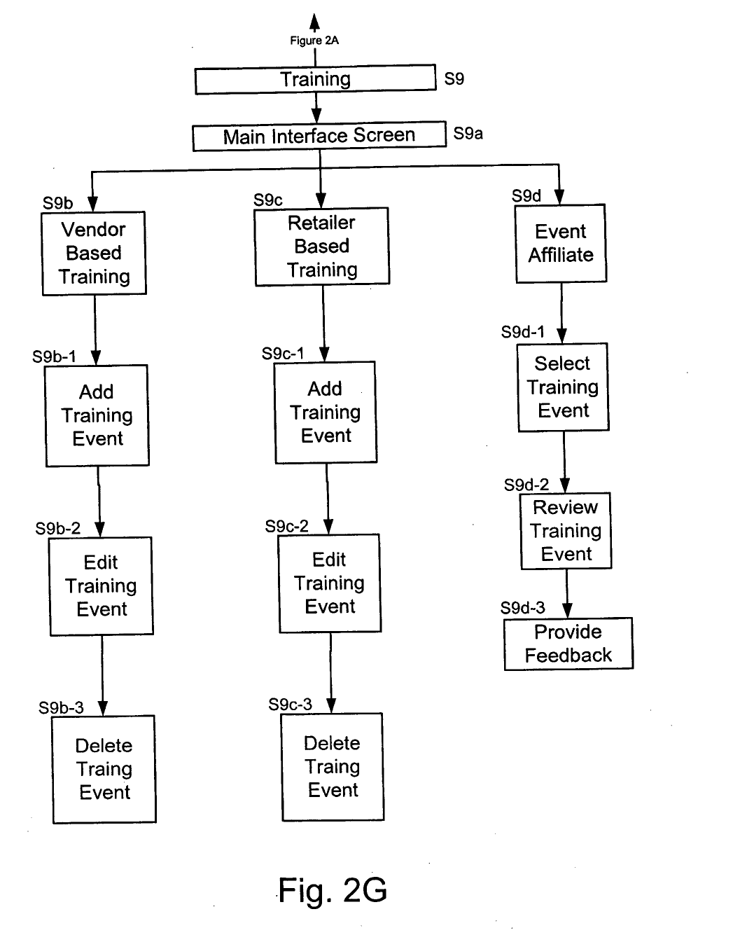

Various aspects of the invention will now be described in detail. In accordance with one embodiment of a system and method of the invention, the system includes user accounts and the method includes the creation and use of accounts. One or more embodiments of such a method will be described first with reference to FIG. 2A. First, at a step S2, an account is established. The account may be established by a party for use by himself or herself or for use by others. As used herein, the person who establishes the account with the coordinator 102 is generally referred to as a client, regardless of whether that person is establishing the account for himself or herself or another party or user. The term “client” is defined as a person or entity that is conducting business transactions with or through the coordinator 102. A client may thus include a retailer 100, a vendor 104 or an event affiliate 106. The account is established by the coordinator 102. As provided below, regardless of whether the account is referred to as a vendor, retailer, event affiliate, coordinator or other named account, the account preferably has certain characteristics that define it, such as by individual requirements of each type of account.

FIG. 2B illustrates a method of establishing an account. At a step S1a, a client interfaces with a coordinator 102. This step may comprise the client accessing a website belonging to the coordinator 102, calling a coordinator customer representative, or accessing one or more other means now known or later developed by which the client may provide information to the coordinator.

At a step S1b, the client provides data to the coordinator 102. This data is used to set up the account. The particular data which is required may vary by provider. In one or more embodiments, the data may include the client's name and/or the name(s) of the parties which are to be permitted to access the account. Since the client is a business, the information may comprise the business name, address, telephone number, taxpayer identification number and/or similar information.

The particular manner by which this information is transmitted to the coordinator 102 may depend upon the interface the client is using. For example, the data maybe input into a graphical user interface associated with the coordinator's website 112 and then sent over the Internet to the coordinator's computer 108 and stored within a database 110. Additionally, the data maybe provided orally over the phone by the client to the coordinator 102. Preferably, data or information provided to the coordinator 102 is stored in electronic format, such as at one or more data storage devices of the system.

At a step S1c, an account type is established. In one or more embodiments, the account type may comprise one or more of the following, depending upon the nature of the client: vendor/supplier, retailer or event affiliate accounts. Those of skill in the art will appreciate that the particular type(s) of accounts and their various features or characteristics maybe different than those provided above. For example, an account may have one or more features associated with or specifically designed for the respective client.

A vendor account is preferably of the type where a vendor may review available retail inventory for selected retailers and order supplies and equipment for the demonstrations. Additionally, the vendor account provides vendors 104 the functionality to pay for services, such as in-store demonstration events, schedule a demonstration, manage vendor account users and manage vendor account information. The vendor may also pay fees (such as transaction fees) that are accessed to the vendor account by the coordinator. In general, the vendor account permits a vendor to schedule an in-store demonstration with a selection of retailers.

A retailer account is preferably of the type where the retailer 100 may manage and view a calendar of dates that the retailer has available for in-store demonstrations. The retailer account further permits the retailer 100 to manage their locations, users and account. Generally, the retailer account provides the retailer 100 with a means to manage the in-store demonstrations as scheduled by the vendor 104.

An event affiliate account is preferably of the type where the event affiliate 106 is a provider of demonstration labor in the local market for the retailer 100. The event affiliate 106 may also provide various supplies and equipment required for the successful completion of the in-store demonstration. By way of the event affiliate account, the coordinator 102 may communicate with an event affiliate 106, such as by providing information regarding in-store demonstrations scheduled by a vendor 104 using the method provided herein.

At a step S1d, the coordinator 102 generates account identifying information, such as an account number, and associates the information, such as account number, with the account. The account number may be used by the coordinator 102 and client to identify the account.

At a step S1e, an account signature is generated and associated with the account. The signature comprises a unique code or other element for establishing entitlement to access the account. In one or more embodiments, the coordinator 102 generates the code based on one or more elements of data associated with the account, such as client provided data, the account number, and/or one or more other elements. In one or more embodiments, the account signature is generated from, or includes, an access code or personal identification number (PIN) data assigned to or selected by the client as described below. In one or more embodiments, the data used to generate the signature maybe input into an encryptor to generate an output which comprises the account signature. The account signature maybe generated randomly as well. Preferably, whatever means is used to generate the signature, each signature is unique for a particular account. In other embodiments, the account signature might be selected or provided by the client.

At a step S1f the account signature is provided to the client. In one or more embodiments, the account signature is mailed to the client, told over the phone by a customer representative of the coordinator 102 to the client, or is transmitted electronically to the client.

At a step S1g, an account access code is generated and associated with the account. In one or more embodiments, the coordinator 102 generates the access code. In other embodiments, the client generates the code and provides it to the coordinator 102. The access code may comprise a personal identification number or “PIN” comprising one or more letters and/or numbers.

At a step S1h, the access code is provided to the client. In the case where the client selects the access code, this step is completed at the same time as step S1e. When the coordinator 102 generates the code, the code may be mailed, electronically transmitted or spoken to the client.

A variety of other steps and maybe associated with the establishment of a client account, and the steps described above need not be completed in the order in which they were described.

Referring again to FIG. 1, at a step S2, a client may access an account, such as their account. This step maybe remote in time from step S1, immediately following creation of the account. For example, a client may establish an account, but not access the account for several days or weeks thereafter. In one or more embodiments, if the client is attempting to access an account, particular account information and associated access data is required. This data may be provided to the coordinator 102 or other account access controlling entity in a number of manners. In one or more embodiments, the account information may be directly provided by the client, as through data input into a website or spoken to an account representative. In one or more embodiments, data must be provided to the coordinator 102 to establish the entitlement of the client to access the designated account. This information may comprise the account signature and/or access code. Again, the particular means and/or method by which this information is provided may vary.

When a client wishes to access an account, at a step S3 it is determined if the access to the account is permitted. In one or more embodiments, this step includes determining if the provided account access information is correct and complete. In one or more embodiments, this step comprises comparing the provided account identification and/or access information to that associated with the account which the client is seeking to access. If the required information has not been provided or is not correct, access to the account is denied. The client may then be directed to contact the coordinator 102 and/or attempt to re-enter the required data in case there was an error in providing or transmitting it to the provider. If the required information correctly corresponds to the account identification and/or access information, the client is permitted to access the account.

If it is determined that access is permitted to the account, then at a step S4, the client is permitted to utilize the account. As described below, a variety of transactions, interactions with and manipulations to the account are permitted.

Referring to FIG. 2C, in one or more embodiments, at a step S5, a vendor 104 is permitted to utilize their account. A variety of methods may be implemented to effectuate this step such as by establishing a communication link with the coordinator 102 and subsequently “logging on” to the system website. In one or more embodiments, at a step S5a, a main interface screen is presented to the vendor 104. The main interface screen may provide several menus and/or modules from which the vendor 104 may use to facilitate the scheduling and coordination of an in-store demonstration. Some examples of the menus/modules that may be initiated include a purchase event, schedule a demonstration, a manage vendor users and a manage vendor account module.

In one embodiment, the system may include a “purchase event” module. This module or aspect of the system maybe configured to provide a vendor 104 with the opportunity to purchase services, such as in the form of in-store demonstration event times, as indicated at a step S5b. The purchases may be permitted in quantity and at wholesale pricing. The vendor 104 maybe permitted to pre-pay or purchase the services, such as for use up to 18 months, thus controlling pricing and permitting planning for future expenditures.

At a step S5b-1, the vendor 104 may select an event type, such as from a predefined list. The list maybe categorized, such as according to level of expertise and difficulty in performing the in-store demonstration. For example, one type of in-store demonstration might be a “standard” demonstration which requires that the demonstrator provide small pre-packaged samples of a particular product. In comparison, another type of demonstration may require that the demonstrator actually cook product samples prior to presentation to a consumer. In the latter example, the cost associated with this type of demonstration will be higher due to the increased skill level required of the demonstrator.

Additionally, at a step S5b-2, the vendor 104 may choose a number of demonstration units to purchase. A single demonstration unit may comprise a 4 or 6 hour (or other designed duration) in-store demonstration. After the vendor 104 determines the event type and number of demonstration unites, a transaction fee is calculated and presented to the vendor. The transaction fee may be effectuated by electronic funds transfer (such as credit card or the like) or by direct payment or other means. In a preferred embodiment, the transaction fee comprises revenue to the coordinator 100, from which system operating and other business expenses are paid.

The system may also be configured with a “schedule a demo” module. This module or aspect of the system may be configured to provides the vendor 104 with the opportunity to set up an in-store demonstration for a particular retailer, as indicated at step S5c. Further, this module includes several steps for the selection and verification of a demonstration.

At a step S5c-1, the vendor 104 enters pertinent information regarding the in-store demonstration. This information may include the designation of a particular retailer 100, desired dates for the demonstration and/or the duration of the in-store demonstration. This step may include a vendor 104 selecting a particular retailer 100, such as from predefined list of available retailers or retailer inventories. Additionally, the module may provide the vendor 104 with a plurality of options regarding the duration of the demonstration. For example, the module may provide a 4 or 6 hour demonstration options or the option to enter a custom duration by way of a dedicated time duration menu.

At a step S5c-2, the vendor maybe presented a menu containing a predefined listing of retailer 100 stores or locations where the demonstrations maybe conducted. The menu listing maybe filtered or arranged according to retail store region, state, store type or other categorical information pertaining to the retail store. Additionally, the retail stores may be presented according to zip code. Preferably, this information may be generated by filtering retail inventory data which is stored in the one or more data storage devices of the central coordination system.

Upon completion of step S5c-2, the vendor 104 may be directed to module/step S5c-3 for selection of supplies and equipment needed to perform the demonstration. At step S5c-3, the vendor 104 is presented an interface detailing various supplies which maybe selected for the demonstration. Some examples of such items are: bowls, paper towels, forks, spoons etc. Some items maybe designated for purchase, while others might be rented. For example, equipment which might be needed to adequately preform a demonstration and which might be rented include: a table, an electric skillet, a microwave, a coffee pot, a blender or a televison. Additionally, this module may provide an interface where the vendor 104 may enter a description or related request and/or comments pertaining to the demonstration.

At a step S5c-4, the vendor 104 may select, such as from a menu, one or more reports that the vendor desires to be provided in association with the demonstration. Generally, as detailed below, these reports will be provided by the event affiliate 106 upon completion of an in-store demonstration. These reports may provide valuable feedback to the vendor 104 regarding the effectiveness of the in-store demonstration, consumer perceptions of the demonstrated product and other valuable marking data. One such report maybe a gross impressions report. This report provides a listing of the total gross impressions produced by the in-store demonstration. Other types of reports are possible and one of ordinary skill in the art would readily be able to implement and make available these reports for selection by the vendor 104.

A review of the vendor 104 configured demonstration information maybe provided, at step S5c-5. This review may be by way of an interface which provides an itemized listing of the demonstration information that was entered by the vendor 104. In this way, the vendor 104 may review, correct and confirm that the proper information was accurately assimilated by the various menus/modules.

At a step S5c-6, the vendor 104 is required to provide payment for use of the coordinator's services, including the system. This step may comprise providing the vendor with an itemized listing of the number of demonstrations scheduled and the transaction fee associated with each demonstration. A means for providing payment via a wire transfer, debit or credit card is presented to the vendor 104. Upon completion of the payment module, the vendor 104 is provided a confirmation of the scheduled demonstrations at step S5c-7. The confirmation includes a contact name, number and email address for a representative from the coordinator 102.

The final step in scheduling a demonstration is provided at step S5c-8, where the pertinent information regarding the in-store demonstration is subsequently provided to the retailer 100 and event affiliate(s) 106 modules for further processing. Both the retailer 100 and event affiliate 106 may use the information provided by this transfer for facilitation of their responsibilities in performing the in-store demonstration.

The system may include a “manage vendor user” module which permits a vendor 104 to manage users of the vendor account. Step S5d-1 allows the vendor 104 to add a user to their account. The vendor 104 maybe required to input information regarding the new user such as: Username, Password, Email Address, First Name, Last Name, and/or User Type. Once all of the pertinent information has been provided, the vendor 104 may activate an “Add User” button to effectuate the addition process for the new user.

Other managerial functionality may be provided, such as the ability to edit a user at step S5d-2. An “Edit User” interface may permit the vendor 104 to modify information regarding the particular user. This information may include: Username, Password, Email Address, First Name, Last Name, and/or User Type. Once the user information is edited to the vendor's satisfaction, the revised information is then uploaded to the coordinator 102 and stored within a database for subsequent access. As indicated at step S5d-3, the vendor 104 may be permitted to delete a user from their account. This module preferably allows the vendor 104 to select and confirm the deletion of a particular user from the vendor account.

The system may include a “manage vendor account” module. This module or aspect of the system may provide the vendor 104 with the functionality to manage informational parameters of the vendor account, as indicated at step S5e. At a step S5e-1, the vendor may be permitted to edit account information such as: Product Vendor Address, City, State, Contact Phone Number, Facsimile Number, Contact Name and Contact Email Address. Once the vendor 104 has completed the modification or editing of the account information, the vendor then uploads the information to the coordinator 102 and the associated database. The uploading process maybe commenced at step S5e-2 by way of the vendor 104 activating an update information button or link provided on the graphical interface of the “manage vendor account” module.

Referring to FIG. 2D, in one or more embodiments, at a step S5, a retailer 100 is permitted to utilize their account. A variety of methods may be implemented to effectuate this step such as by establishing a communication link with the coordinator 102 and subsequently “logging on” to the system website. In one or more embodiments, at a step S6a, a main interface screen is presented to the retailer 100 that has accessed the account. A main interface screen may provide several menus and/or modules from which the retailer 100 may use to facilitate the oversight and management of in-store demonstrations. Some examples of the menus/modules that may be initiated include a view calendar, manage retailer locations, a manage retailer users and a manage retailer account module.

The system may include a “view calendar” module. This module or aspect of the system may provide the retailer 100 with the opportunity to view a calendar specific to the retailer account within a secure networking environment, as indicated at step S6b. The calendar dynamically updates each time a vendor 104 schedules a new demonstration. The initial calendar that is presented to the retailer 100 displays an 18 month interval. At a step S6b-1, the retailer 100 may select a particular month for further review. Upon selection of a particular month, the calendar will present the retailer 100 at step S6b-2 with a calendar display including the scheduled in-store demonstrations for that particular month. The retailer 100 may designate available dates, times and other requirements for an in-store demonstration. Additionally, the retailer 100 may designate the number of events per month, times, in-store locations (such as, Deli, Dairy, Front of store, etc.), and the types of demonstrations (coupon hand out, product sampling, cooking, etc.).

The system may include a “manage retailer locations” module. This module or aspect of the system may enable the retailer 100 to add, edit or delete a retail store location, as indicated at step S6c. By having the retailer 100 provide current and up-to-date information regarding retail stores, the system is kept current and the vendors 104 have access to accurate information. At a step S6c-1, the retailer 100 may add a store location to the database of information retained by the coordinator 102. The retailer 100 may add a store by providing pertinent information regarding the new retail store such as: Store Address, Contact Phone Number, Facsimile Number, Contact Name and Contact Email Address. Once the retailer 100 has completed the addition of a retail store, the modified data is then uploaded to the coordinator 102 and stored in a database 110 for subsequent access.

A retailer 100 may subsequently edit a location at step S6c-2. At this step, the retailer 100 may modify pertinent information regarding each retail store. This information may include: Store Address, Contact Phone Number, Facsimile Number, Contact Name and Contact Email Address. For example, a retail store may have a change in management personnel and the previous contact name and contact email would need to be updated with information corresponding to the new management personnel. Once the retailer has completed the editing of specific retail store information, the modified data is then uploaded to the coordinator 102 and stored in a database 110 for subsequent access.

The system may include a “manage retail user” module. This module or aspect of the system may provide the Retailer 100 with the functionality to manage users of the retailer account, as indicated at step S6d. As indicated at step S6d-1, the retailer 100 may add a user to their account. The retailer 100 may be required to input information regarding the new user such as: Username, Password, Email Address, First Name, Last Name, and/or User Type. Once all of the pertinent information has been provided, the retailer 100 may activate an “Add User” button to effectuate the addition process for the new user.

Other managerial functionality maybe provided, such as the ability to edit a user as indicated at step S6d-2. The “Edit User” interface may permit the retailer 100 to modify information regarding the particular user. This information may include: Username, Password, Email Address, First Name, Last Name, and/or User Type. Once the user information is edited to the retailer's 100 satisfaction the revised information is then uploaded to the coordinator 102 and stored within a database for subsequent access. As indicated at step S6d-3, the retailer may delete a user from their account. This module or step preferably allows the retailer 100 to select and confirm the deletion of a particular user from the retailer account.

The system may include a “manage retailer account” module. This module or aspect of the system may provide the retailer 100 with the functionality to manage informational parameters of the retailer account, as indicated at step S6e. As indicated at step S6e-1, the retailer 100 may be permitted to edit account information such as: Retailer Address, City, State, Contact Phone Number, Facsimile Number, Contact Name and Contact Email Address. Once the retailer 100 has completed the modification or editing of the account information, the retailer 100 then uploads the information to the coordinator 102 and the associated database 110. The uploading process may be commenced at step S6e-2 by way of the retailer 100 activating an update information button or link provided on the graphical interface of the “manage retailer account” module.

Reference is now made to FIG. 2E, in one or more embodiments, at a step S7, an event affiliate 106 is permitted to utilize their account. A variety of methods maybe implemented to effectuate this step such as by establishing a communication link with the coordinator 102 and subsequently “logging on” to the system website. In one or more embodiments, at a step S7a, a main interface screen is presented to the event affiliate 106 that has accessed the account. The main interface screen provides several menus and/or modules from which the event affiliate 106 may use to review and provide labor, supplies and equipment for scheduled in-store demonstrations. Some examples of the menus/modules that may be initiated include an edit rates, pre-demo reports, post-demo report, a manage event affiliate users and a manage event affiliate account module.

The system may include an “edit rates” module. This module or aspect of the system may provide the event affiliate 106 with the functionality to edit the demonstration type hourly rate, as indicated at step S7b. At a step S7b-1, the event affiliate 106 may edit the hourly rate associated with each demonstration level for the specific event affiliate account. The event affiliate 106 is provided an interface for selecting demonstration level for modification from a predefined list of demonstration levels. The following Table 1 provides an exemplary listing of the demonstration levels and hourly rates based on the number of demonstration units purchased.

TABLE 1

| Demonstration | | | | | |
|---|---|---|---|---|---|
| Units | 0–10K | 10K–25K | 25K–50K | 50K or More | |
| Standard | $22 | $21 | $20 | $19 | Edit |
| Retailtainment | $27 | $26 | $25 | $24 | Edit |
| Cooking | $27 | $26 | $25 | $24 | Edit |
| Coupon | $20 | $19 | $18 | $17 | Edit |
| Hand-out | | | | | |
| Sports | $25 | $24 | $23 | $12 | Edit |

In one embodiment, there are five predefined demonstration levels. The demonstration levels are categorized according to level of expertise and difficulty in performing the in-store demonstration. For example, one type of in-store demonstration is considered “standard” and basically requires that the demonstrator provide small pre-packaged samples of a particular product. In comparison, another type of demonstration may require that the demonstrator actually cook product samples prior to presentation to a consumer. In still another type of demonstration level (coupon hand-out), the demonstrator hands out coupons for a particular good or service. Another type of demonstration level is “Retailtainment” such as the game of cookie stacking. Where participants race against the clock to stack cookies. This provides both a sampling event and a form of entertainment for the consumer. The fifth type of demonstration level is a “Sports” demonstration which may comprise a sports-event premised demonstration.

Once the event affiliate 106 has selected a demonstration level for modification, the interface provides a means for inputting, confirming and uploading a new hourly rate for the selected demonstration level. In the preferred embodiment, the event affiliate 106 may only update the hourly rates once per year to protect the coordinator 102 and the vendors 104 from frequent price increases. However, other intervals for hourly rate updates may be established between the primary entities involved. Upon completing the modification of the hourly rates, the event affiliate 106 uploads the revised information to the coordinator 102 and associated database for future access.

The system may include an “pre-demo report” module. This module or aspect of the system may facilitate the production important information regarding the scheduled in-store demonstration, as indicated at step S7d. It is contemplated that this information, such as in the form of a “pre-demo report” will be sent to the vendor 104 within a time period, such as 30 days, of scheduling the demonstration. Creation of a pre-demo report may be initiated at step S7c-1, where the event affiliate 106 receives notification that an in-store demonstration has been scheduled by a vendor 104. This notification may include information such as dates, times, location, duration and other information pertinent to the demonstration. After the notification is received by the event affiliate 106, the next step is S7c-2 where the event affiliate provides a confirmation of the demonstration order to the vendor 104. At step S7c-3 the event affiliate 106 provides and estimate of the time to complete the order as confirmed at step S7c-2. Next, at step S7c-4 the event affiliate 106 provides the vendor 104 with an invoice pertaining to the scheduled in-store demonstration. For example, the invoice may itemize charges to be accessed for the actual demonstration labor, supplies ordered and equipment rented.

A list is generated, such as at step S7c-5, that itemizes the requested reports as selected by the vendor 104 as previously described above at step S5c-4. The list preferably confirms each report that will be provided upon completion of the in-store demonstration. One example of a report would be the “gross impressions” report.

The final step implemented by the pre-demo report module is step S7c-6 where the event affiliate 106 summarizes the specifics of the in-store demonstration and what is required from the event affiliate 106. This summary may include a listing of the locations being serviced and items included in the invoice of step S7c-4.

The system may include a “post-demo reports” module. This module or aspect of the system may generate the specific reports requested by the vendor 104 during the scheduling process, as indicated at step S7d. It is contemplated that the event affiliate 106 will complete the post-demo reports within a certain period of time, such as 3 days, of completing the in-store demonstration. Data for the post-demo reports maybe acquired from the demonstration labor employee by way of a short questionnaire that is provided to the employee at step S7d-1. The questionnaire may include information such as the in-store demonstration's performance, consumer reaction and information requests tailored to the specific reports that were requested by the vendor 104. After the employee completes the questionnaire, the information is provided to the event affiliate 106 and subsequently entered into the module at step S7d-2 for further processing and utilization in the post-demo reports. Upon completion of the information gathering, the event affiliate 106 generates the specific reports requested by the vendor 104 at step S7d-3. These completed reports are subsequently provided to the vendor 104 by direct mail, facsimile, email or other communication methods now known or later developed.

In one embodiment, the informational gathering of step S7d-1 may include productivity and timeliness data regarding the demonstration labor employee. Such information may include time sheets, check-in/check-out times, break times and other data that pertains to the employee's efficiency. Additionally, this data maybe gathered by using a standard time-clock or by checking in and out using a cellular phone or two-way satellite communication device. In another embodiment, the demonstration labor employee's location maybe monitored by way of a satellite tracking system. An example of such a system may be a Global Positioning System or GPS device that is assigned to a particular employee to use during the demonstration.

The system may include a “manage event affiliate user” module. This module or aspect of the system may provide the event affiliate 106 with the functionality to manage users of the event affiliate account, as indicated at step S7e. Step S7e-1 allows the Event Affiliate 106 to add a user to their account. The event affiliate 106 maybe required to input information regarding the new user such as: Username, Password, Email Address, First Name, Last Name, and/or User Type. Once all of the pertinent information has been provided, the event affiliate 106 may activate an “Add User” button to effectuate the addition process for the new user.

Other managerial functionality may be provided such as the ability to edit a user at step S7e-2. The “Edit User” interface permits the event affiliate 106 to modify information regarding the particular user. This information may include: Username, Password, Email Address, First Name, Last Name, and/or User Type. Once the user information is edited to the satisfaction of event affiliate 106, the revised information is then uploaded to the coordinator 102 and stored within a database for subsequent access. At a step S7e-3, the event affiliate 106 may delete a user from their account. This module preferably allows the event affiliate 106 to select and confirm the deletion of a particular user from the retailer account.

The system may include a “manage event affiliate account” module. This module or aspect of the system may provide the event affiliate 106 with the functionality to manage informational parameters of the event affiliate account, as indicated at step S7f. As indicated at step S7f-1, the event affiliate 106 may edit account information such as: Event Affiliate Address, City, State, Contact phone number, Facsimile number, Contact Name and Contact Email Address. Once the event affiliate 106 has completed the modification or editing of the account information, the event affiliate 106 then uploads the information to the coordinator and the associated database. The uploading process may be commenced at step S7f-2 by way of the event affiliate 106 activating an update information button or link provided on the graphical interface of the “manage event affiliate account” module.

Turning now to FIG. 2F, in one or more embodiments, at a step S8, a coordinator 102 is permitted to access and manage the system. A variety of methods maybe implemented to effectuate this step such as by establishing a communication link with the computer server and subsequently “logging on” to the system website. In one or more embodiments, at a step S8a, a main interface screen is presented to the coordinator 102. The main interface screen provides several menus and/or modules from which the coordinator 102 may use to manage various aspects such as in-store demonstration event management. Some examples of the menus/modules that maybe initiated include manage event affiliate time, manage demonstrations, manage coordinator users, manage all users, and manage account module.

The system may include a “manage event affiliate time” module. This module or aspect of the system may provide the coordinator 102 with the functionality to edit the demonstration times of an event affiliate 106, as indicated at step S8b. In a preferred embodiment, the event affiliate 106 is allocated a maximum amount of demonstration labor hours that they may provide each month. At a step S8b-1, the coordinator 102 may add times for a selected event affiliate 106 by selecting the event affiliate from a predefined listing of current affiliates. The module provides for data input by coordinator 102 personnel. Once the data regarding the demonstration times is entered it is uploaded to the database 110 for further processing and subsequent access. Event affiliate demonstration labor times maybe edited at step S8b-2. This aspect of the module permits the coordinator 102 to select a particular event affiliate 106 and edit, modify or revise demonstration times associated with the selected event affiliate. Finally, at step S8b-3 the coordinator 102 may delete demonstration times associated with a previously selected event affiliate 106.

The system may include a “manage demonstration” module. This module or aspect of the system may provide the coordinator 102 with the functionality to review all scheduled demonstrations for a particular retailer 100, as indicated at step S8c. The review may be by viewing the calendar associated with the retailer and, more particularly, demonstrations scheduled for a specific store location. The coordinator 102 may review and/or modify specific aspects of a selected demonstration such as booking, confirmation and tracking. Also, the coordinator 102 may assist in scheduling, tracking, and generating a time-line for important requirements. Additionally, the coordinator 102 may schedule an in-store demonstration for a specified vendor.

The system may include a “manage coordinator user” module. This module or aspect of the system may provide the coordinator 102 with the functionality to manage Coordinator users of the system such as account representatives or liaisons, as indicated at step S8d. As indicated at step S8d-1, the coordinator 102 may add a user to their account. The coordinator 102 may be required to input information regarding the new user such as: Username, Password, Email Address, First Name, Last Name, and/or User Type. Once all of the pertinent information has been provided, the coordinator 102 may activate an “Add User” button to effectuate the addition process for the new user.

Other managerial functionality may be provided such as the ability to edit a user at step S8d-2. The “Edit User” interface permits the coordinator 102 to review and/or modify information regarding the particular user. This information may include: Username, Password, Email Address, First Name, Last Name, Date Added, Number of Logins and/or User Type. Once the user information is edited to the satisfaction of coordinator 102, the revised information is then uploaded to the computer server 108 and stored within a database 110 for subsequent access. At a step S8d-3, the coordinator 102 may delete a user from their account. This module preferably allows the coordinator 102 to select and confirm the deletion of a particular user from the account.

The system may include a “manage all users” module. This module or aspect of the system may provide the coordinator 102 with the functionality to manage all users of the coordination system, as indicated instep S8e. As indicated at step S8e-1,the coordinator 102 may add a user to the system. The Coordinator 102 may be required to input information regarding the new user such as: Username, Password, Email Address, First Name, Last Name, and/or User Type. Once all of the pertinent information has been provided, the Coordinator 102 may activate an “Add User” button to effectuate the addition process for the new user.

Additionally, other managerial functionality may be provided such as the ability to edit a user at step S8e-2. The “Edit User” interface permits the coordinator 102 to modify information regarding the particular user. This information may include: Username, Password, Email Address, First Name, Last Name, and/or User Type. Once the user information is edited to the satisfaction of coordinator 102, the revised information is then uploaded to the computer server 108 and stored within a database 110 for subsequent access. At a step S8e-3, the coordinator 102 may delete a user from system. This module preferably allows the Coordinator 102 to select and confirm the deletion of a particular user from the retailer account.

The system may include a “manage account” module. This module or aspect of the system may provide the coordinator 102 with the functionality to manage informational parameters of the in-store demonstration coordination system of the present invention, as indicated at step S8f. As indicated at step S8f-1, account information such as: Coordinator Address, City, State, Contact phone number, Facsimile number, Contact Name and Contact Email Address may be edited. Once the coordinator 102 has completed the modification or editing of the account information, the coordinator 102 then uploads the information to the computer server 108 and the associated database 110. The uploading process may be commenced at step S8f-2 by way of the coordinator 102 activating an update information button or link provided on the graphical interface of the “manage account” module.

Referring to FIG. 2G, in one or more embodiments, at a step S9, the system may include a training module or aspect. This training aspect of the invention maybe applicable to, and thus accessible to, the retailer 100, vendor 104 and event affiliate 106. After a primary entity has accessed their account the training module maybe available for selection if desired by the user. In one or more embodiments, at a step S9a, a main interface screen is presented to the primary entity that has accessed their account. The main interface screen provides several menus and/or modules for selection by the user. Some examples of the menus/modules that maybe initiated include a vendor based training module, a retailer based raining module and an event affiliate module.

As indicated by step S9b, a vendor 104 may manage training materials specific to the goods and/or services provided by the vendor. The vendor 104 may “add” a training event, as indicated at step S9b-1. At this step the vendor 104 designates and uploads various training materials to the computer server and associated database for further review by the event affiliate 106. Training material may comprise documentation, video, or audio files that provide information and instruction regarding various aspects of the products/services of the vendor 104. The vendor 104 may “edit” a training event, as indicated at step S9b-2. During the editing process, the vendor 104 may review, revise or otherwise modify a previously added training event. Upon completion of the editing process, the vendor 104 uploads the modified information to the computer server for storage within a database. Finally, the vendor 104 may “delete” a training event at step S9b-3. At this step, the vendor 104 selects a previously added or edited training event for deletion. It is contemplated that the vendor 104 would be requested to provide verification and confirmation prior to deleting the training event.

The retailer 100 maybe permitted, as indicated at step S9c, to manage training materials specific to the retailer's business or store procedures. As indicated at step S9c1, the retailer 100 may “add” training related materials for use by other entities involved in the in-store demonstration. These training materials maybe uploaded by the retailer 100 to the computer sever and subsequently stored within a database for future access. The retailer 100 training events may comprise information and/or procedures for conducting the in-store demonstration such as preferred set-up and tear-down procedures, store safety training and other information that maybe important to the demonstration labor employees. Next, at step S9c-2, the retailer 100 may “edit” a previously provided training event. The module provides the retailer 100 with a listing of previously uploaded training events from which the retailer 100 may select for review, revision or modification. After the retailer 100 is satisfied with the revisions to a training event, the modified information is uploaded to the computer server for subsequent storage within a database. At a step S9c-3, the retailer 100 may delete a training event by selecting the event, verifying and confirming the deletion of the event.

As indicated at step S9d, an event affiliate 106 maybe permitted to access various training materials and/or events that have been uploaded by the retailer 100 and/or vendor 104. To initiate the training process, the event affiliate 106 or designated user selects the type of training they require at step S9d-1. The event affiliate 106 may choose from training events posted by the vendor 104 associated with the in-store demonstration or the retailer 100 involved with the demonstration. The training may consist of instruction on how to perform, set-up or take-down the demonstration. Additionally, the training may comprise instruction/advise on dealing with the consumers and how to interact with other personnel involved with the in-store demonstration. As indicated at step S9d-2, the event affiliate 106 actually participates and/or reviews the training event. Finally, at step S9d-3, the event affiliate 106 is provided the opportunity to comment on the training event/materials. By providing the vendor 104 or retailer 100 with information regarding the effectiveness of the training materials, the training and associated benefits will increase overtime because there is a mechanism in place to correct and/or comment upon deficiencies in the training event.

As indicated, in one embodiment the system comprises a coordinator system comprising one or more host computing devices. Preferably, retailers, event affiliates and vendors access or communicate with the coordinator system. In one embodiment, such parties may utilize a remote computing device, such as a desktop or laptop computer, to access the coordinator system.

As further indicated, the system includes various modules. These modules need not comprise physically separate elements. For example, system may incorporate various hardware and/or software to implement the method. In one embodiment, software might be “modular” in the sense that various portions thereof are particularly directed to implementing particular functionality. However, such portions of the software may be required to integrate with one another.

While in the preferred embodiment information is presented in web page or similar format and information maybe transmitted over the Internet, other configurations are possible. For example, various information might be transmitted in paper or other printed format. Data might also be stored on a storage media, such as a CD-Rom or DVD, for exchange between the parties.

While the method has been described with reference to particular steps, it should be appreciated that the steps need not be performed in the particular order that they are described. Further, the method might comprise other or additional steps. It will also be appreciated that other systems than described above may be configured to implement the invention.

The systems and methods of the invention have numerous advantages over the current process for arranging in-store demonstrations. First, the system and method permits a vendor to conveniently determine the location and times which retailers have available for demonstrations (a “retail inventory”). This saves the vendor substantial time in having to contact individual retailers or stores to determine such information. The system and method also enable a vendor to reserve demonstration times with various retailers and over a long period of time.

The system and method facilitates arranging demonstration labor. The vendor no longer has to negotiate around a middleman to acquire demonstration labor and, as a consequence, the labor rate can be substantially reduced. The system and method provides the vendor with the ability to conveniently schedule and confirm in-store labor rates and arrange for necessary demonstration supplies and rental equipment, via the central coordinator. The coordinator preferably directly deals with labor or supplies provider, thus eliminating the “layers” of middlemen.

The system and method provides a participating retailer with a workable standard in which to manage their in-store demonstrations. The system and method permits the retailer to review the scheduled demonstrations up to 18 months in advance. The system and method further provides the retailer with the ability to adequately schedule and manage the timing and complexity of in-store demonstrations on a timely basis. Additionally, the retailer may allocate specific stores and store space for the demonstrations, which is very helpful in high demand times such as around the holiday season. Because vendors utilize the system and method to reserve demonstration time, the retailer is no longer burdened by having to respond to vendors calling for information regarding available demonstration times and locations.

The system and method further benefits event affiliates because they are now in direct communication with the vendor and there is less opportunity for error in the logistics process. The event affiliate has the ability to schedule and manage their workforce of demonstration labor employees. Correspondingly, the present method provides for price protections for both the vendor and event affiliate. Also, the vendor may receive a series of accountability and productivity reports associated with the in-store demonstration. By providing these reports, the event affiliates are held accountable with regards to their employees. Additionally, the reports provide the vendor a way to measure and monitor the effectiveness and productivity gains from the in-store demonstration event.

It will be understood that the above described arrangements of the system and method there from are merely illustrative of applications of the principles of this invention and many other embodiments and modifications maybe made without departing from the spirit and scope of the invention as defined in the claims.

I claim:

1. A method of facilitating and coordinating an in-store demonstration of vendor products by a coordinator, said method comprising the steps of:
obtaining at least one retail inventory information from one or more retailers, said retail inventory information comprising at least information regarding a retail store location and date and time availability for an in-store demonstration;
providing said retail inventory information to one or more vendors desiring to present an in-store demonstration;
receiving at least one in-store demonstration reservation from said one or more vendors, said at least one reservation corresponding to at least one of said retail inventory information;
accepting payment each vendor making a reservation, said payment comprising a service fee associated with facilitating and coordinating said in-store demonstration;
communicating with one or more event affiliates to acquire labor and associated supplies for effectuating said in-store demonstration; and
providing a schedule to said one or more retailers, said one or more vendors, said one or more event affiliates, said schedule comprising information pertaining to said in-store demonstration.

2. The method in accordance with claim 1 including the step of said one or more event affiliates providing labor and conducting the in-store demonstration.

3. The method in accordance with claim 2 including the step of paying a fee directly to said one or more event affiliates for conducting the in-store demonstration.

4. The method in accordance with claim 1 further comprising the step of providing at least one vendor report corresponding to each conducted in-store demonstration.

5. The method in accordance with claim 4 wherein said report comprises an effectiveness analysis of the in-store demonstration.

6. The method in accordance with claim 4 wherein said report comprises an accountability analysis with respect to the one or more event affiliates conducting the in-store demonstration.

7. The method in accordance with claim 1 wherein the retail inventory information is posted for at least 12 months in advance.

8. The method in accordance with claim 1 wherein the step of receiving reservations from one or more vendors further comprises presenting said one or more vendors a plurality of choices for demonstration levels for said in-store demonstration.

9. The method in accordance with claim 8 wherein said service fee is adjusted with the demonstration level chosen by said vendor.

10. The method in accordance with claim 1 wherein said retail inventory information is subsequently modifiable by said retailer.

11. The method in accordance with claim 1 further comprising the step of providing training related materials to said one or more event affiliates.

12. A system for facilitating and coordinating an in-store demonstration of a vendor's products comprising:
one or more computing devices running a machine executable code, said code configured to:
permit one or more vendors to establish an account with respect to said system and store account information;
permit one or more vendors to access said account;
receive and store retail inventory information from one or more retailers, said retail inventory information comprising at least information regarding a retail store location and date and time availability for an in-store demonstration;
display retail inventory information over a network to said one or more vendors desiring to present an in-store demonstration;
receive and store at least one in-store demonstration reservation from said one or more vendors, said at least one reservation corresponding to at least one of said retail inventory information;
accept and process payment from each vendor making a reservation, said payment comprising a service fee associated with facilitating and coordinating said in-store demonstration;
transmit information to one or more event affiliates to acquire labor and associated supplies for effectuating said in-store demonstration; and
provide a schedule to said one or more retailers, said one or more vendors, said one or more event affiliates, said schedule comprising detailed information pertaining to said in-store demonstration.

13. The system in accordance with claim 12 wherein said one or more computing device include at least one communication port configured to form a portion of a communication link with a computing device of a vendor.

14. The system in accordance with claim 12 wherein said one or more computing device are configured to display said retail inventory information as one or more web page accessible via a communication network.

15. The system in accordance with claim 12 wherein said system is further configured to provide at least one report based upon information received from the one or more event affiliates.

16. The system in accordance with claim 15 wherein said report comprises an effectiveness analysis of the in-store demonstration.

17. The system in accordance with claim 15 wherein said report comprises an accountability analysis with respect to the one or more event affiliates conducting the in-store demonstration.

18. The system in accordance with claim 12 wherein the retail inventory information is posted for at least 12 months in advance.

19. The system in accordance with claim 12 wherein said system is further configured to present said one or more vendors a plurality of choices for demonstration levels for said in-store demonstration.

20. The system in accordance with claim 12 wherein said system is further configured to provide training related materials.
